(19) United States
(12) Patent Application Publication
(10) Pub. No.: US 2024/0424517 A1
(43) Pub. Date: Dec. 26, 2024

(54) PAINTING SYSTEM FOR AN AIRCRAFT COMPRISING A PAINT BOOTH OF REDUCED CROSS SECTION

(71) Applicants: Airbus SAS, BLAGNAC (FR); Airbus Operations S.L., GETAFE (ES); Airbus Operations GmbH, HAMBURG (DE)

(72) Inventors: Wladislav LAGUTIN, HAMBURG (DE); Juan Francisco GARCIA AMADO, GETAFE (ES); Boris MORINIERE, ROCHEFORT (FR)

(21) Appl. No.: 18/751,620

(22) Filed: Jun. 24, 2024

(30) Foreign Application Priority Data
Jun. 26, 2023 (FR) 2306619

(51) Int. Cl. B05B 16/80; B05B 16/40

(52) U.S. Cl. CPC B05B 16/80; B05B 16/40

(57) ABSTRACT

A painting system suitable for painting a fuselage of an aircraft, including a paint booth which is positioned on a platform. This paint booth includes at least first and second lateral openings which are configured to permit the wings of the aircraft to pass through the paint booth, in addition to at least two elements, at least one thereof being mobile between an adjacent position corresponding to a closed state of the paint booth in which the two elements are joined together, in addition to a spaced-apart position corresponding to an open state of the paint booth in which the fuselage can be positioned between the two elements.

### CROSS-REFERENCES TO RELATED APPLICATIONS

This application claims the benefit of French Patent Application Number 2306619 filed on Jun. 26, 2023, the entire disclosures of which are incorporated herein by way of reference.

### FIELD OF THE INVENTION

The present application relates to a painting system for an aircraft comprising a paint booth of reduced cross section.

### BACKGROUND OF THE INVENTION

According to one embodiment, an aircraft comprises a fuselage, wings arranged on either side of the fuselage, in addition to a tail unit positioned in the region of the rear tip of the fuselage.

Once assembled, the aircraft is positioned in a painting hanger which is substantially parallelepipedal and which is dimensioned to contain the aircraft so that it can be sanded and then painted therein. Taking account of the dimensions of the tail unit and the wings, the ceiling and the lateral walls of the hanger are at a distance from the fuselage.

The operation of sanding the aircraft generates fine particles which remain in suspension around the aircraft and/or are deposited on the ground, the surfaces of the aircraft and/or the hanger. During the painting operation, these fine particles can become suspended again and deposited on the freshly painted surfaces of the aircraft. At the same time, since the paint is applied by spraying onto the surfaces of the aircraft, a part of this sprayed paint is not deposited on the surfaces of the aircraft and generates a cloud of paint. In order to limit the deposit of paint on the walls and ceiling of the painting hanger, this hanger is provided with at least one ventilation and extraction system comprising at least one ventilation outlet which is configured to inject an airflow into the painting hanger, in addition to an extraction outlet which is configured to extract the air present in the painting hanger. Taking account of the large dimensions of the painting hanger, the operation of the ventilation and extraction system is energy-intensive due to the significant volume to be treated.

According to a further drawback, after its application, the paintwork is dried during a drying step which requires the temperature to be maintained at a given value inside the hanger. Taking account of the volume of air present in the hanger, this maintaining of the temperature is energy-intensive.

### SUMMARY OF THE INVENTION

The present invention aims to remedy entirely or partially the drawbacks of the prior art. To this end, the subject of the invention is a painting system suitable for painting a fuselage of an aircraft, the aircraft comprising wings and a tail unit, and each wing forming a given angle with the fuselage and the painting system comprising a platform.

According to the invention, the painting system comprises a paint booth which is positioned on the platform and which comprises at least first and second lateral openings which are configured to permit the wings of the aircraft to pass through the paint booth, in addition to at least two elements, at least one of the two elements being mobile between an adjacent position corresponding to a closed state of the paint booth in which the two elements are joined together, in addition to a spaced-apart position corresponding to an open state of the paint booth in which the fuselage can be positioned between the two elements. This solution makes it possible to obtain a paint booth of small sections which are adapted to those of the fuselage, which makes it possible to reduce the volume of air to be treated by a ventilation and extraction system or to be heated for drying the paintwork. Thus it is possible to reduce the consumption of energy and to simplify and optimize the management of the characteristics of the air (temperature, humidity, quality, etc.).

According to a further feature, the paint booth comprises an upper opening which is dimensioned to permit the tail unit to pass through the paint booth.

According to a further feature, the paint booth comprises at least first and second parts, the first part comprising at least one part of a first lateral wall, in addition to a first portion of an upper wall, the second part comprising at least one part of a second lateral wall, in addition to a second portion of the upper wall, the first and second portions of the upper wall being joined together when the first and second parts are in the adjacent position, and the first and second portions of the upper wall comprising cutouts so as to form the upper opening when the first and second parts are in the adjacent position.

According to a further feature, the first and second parts are mobile between the adjacent and spaced-apart positions and symmetrical relative to a vertical median plane.

According to a further feature, for each of the first and second parts, the painting system comprises at least one sliding link which connects the first or second part and the platform and which is configured to permit the first or second part to be translated between the adjacent and spaced-apart positions, each sliding link forming with the vertical median plane an angle which is substantially equal to that formed between the fuselage and each wing.

According to a further feature, the paint booth comprises first and second sections respectively comprising first and second terminal faces which are positioned in transverse planes perpendicular to the vertical median plane, at least one of the first and second sections being mobile between a first position in which the first and second transverse faces are placed against one another, in addition to a second position in which the first and second transverse faces are spaced apart from one another.

According to a further feature, the first section is fixed. In addition, the second section comprises first and second parts which are mobile between a position which is spaced apart from the vertical median plane and a position which is adjacent to the vertical median plane.

According to a further feature, the first section comprises the first and second lateral openings which open out in the region of the first terminal face.

According to a further feature, the paint booth comprises at least one flexible barrier which is configured to fill up a space between the cockpit and the tail unit and completely seal the upper opening.

According to a further feature, the paint booth comprises at least one flexible barrier for at least one of the first and second lateral openings, the flexible barrier being configured to fill up a space between the paint booth and the wing and thus completely seal the first or second lateral opening.

According to a further feature, the paint booth comprises a structure which is configured to support the walls, in addition to a plurality of longitudinal sliders which are fixed to the structure, which are parallel to one another and which are configured to permit at least one support to be displaced along the fuselage which is positioned in the paint booth by sliding along the slider.

### BRIEF DESCRIPTION OF THE DRAWINGS

Further features and advantages will be found in the following description of the invention which is given solely by way of example, with reference to the accompanying drawings, in which:

FIG. 1 is a perspective view according to a first viewing angle of a painting system, comprising a paint booth in the open state, illustrating an embodiment of the invention,

FIG. 2 is a perspective view according to a second viewing angle of the painting system visible in FIG. 1,

FIG. 3 is a perspective view of a structure of a paint booth, in the open state, illustrating an embodiment of the invention,

FIG. 4 is a perspective view of the structure of the paint booth visible in FIG. 3 in the closed state,

FIG. 5 is a rear view of a painting system illustrating an embodiment of the invention,

FIG. 6 is a perspective view of a part of a structure of a paint booth illustrating an embodiment of the invention,

FIG. 7 is a perspective view of a part of a structure of a paint booth illustrating an embodiment of the invention,

FIG. 8 is a perspective view of a lower part of a paint booth provided with extraction outlets illustrating an embodiment of the invention,

FIG. 9 is a schematic lateral view of a ventilation and extraction system illustrating an embodiment of the invention,

FIG. 10 is a schematic perspective view of a ventilation and extraction system illustrating an embodiment of the invention,

FIGS. 11A and 11B are perspective views of a part of a ventilation and extraction system comprising mobile extraction outlets, in the retracted position in FIG. 11A and in the deployed position in FIG. 11B, illustrating an embodiment of the invention.

### DETAILED DESCRIPTION OF THE PREFERRED EMBODIMENTS

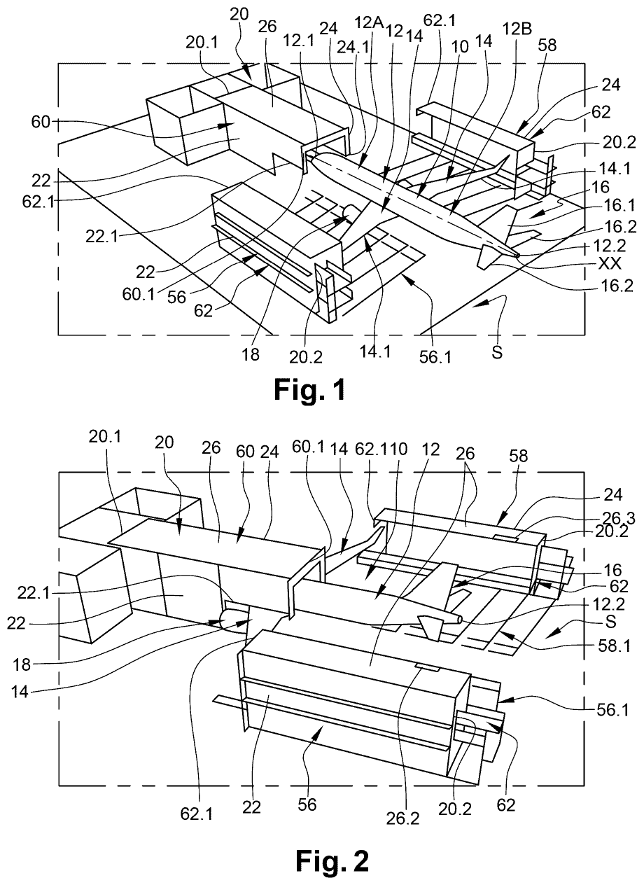

According to an embodiment visible in FIG. 1, an aircraft 10 comprises a fuselage 12 which extends between a front tip 12.1 and a rear tip 12.2 of the wings 14 which extend on either side of the fuselage 12, in addition to a tail unit 16 which is positioned in the region of the rear tip 12.2, comprising a vertical part 16.1, in addition to horizontal parts 16.2 located on either side of the rear tip 12.2. The aircraft 10 has an aircraft longitudinal axis XX which is horizontal when the aircraft 10 is on the ground and which passes through the front and rear tips 12.1, 12.2.

The fuselage 12 has a length corresponding to a dimension of the fuselage 12 taken horizontally from the front tip 12.1 to the rear tip 12.2, in addition to a width corresponding to a dimension of the fuselage 12 taken horizontally in a transverse plane perpendicular to the aircraft longitudinal axis XX. The fuselage 12 has a front part 12A located upstream of the wings 14, in addition to a rear part 12B located downstream of the wings 14. Each wing 14 comprises a trailing edge 14.1 and forms a given angle with the fuselage 12, this angle being measured between the trailing edge 14.1 and the fuselage 12.

The aircraft 10 comprises propulsion systems 18 which are connected to the wings 14 and spaced apart from the fuselage 12.

As illustrated in FIG. 5, a painting system which is suitable for painting an aircraft 10 comprises a paint booth 20 which is located, inside a hanger, on a platform S (such as the ground) which is configured to permit an aircraft, which is to be painted, to be parked therein, the paint booth 20 comprising first and second lateral walls 22, 24 which are parallel to one another, in addition to an upper wall 26 which is remote from the platform S, which is substantially parallel to the platform S and which connects the first and second lateral walls 22, 24. The hanger in which the paint booth 20 is positioned is dimensioned so as to permit an aircraft to pass therein. The tunnel-shaped paint booth 20 separates an internal zone, which is located between the walls 22, 24, 26 and the platform S, and an external zone. The paint booth 20 extends between the first and second ends 20.1, 20.2. According to one arrangement, the upper wall 26 is substantially horizontal and the first and second lateral walls 22, 24 are substantially vertical.

Naturally, the invention is not limited to the painting operation. Thus the painting system can be used to carry out preparatory operations before the painting operation, such as an initial inspection operation, sanding operation, cleaning operation, masking operation, for example, and/or subsequent operations such as a decorating operation, final inspection operation, for example.

Moreover, it is possible for the painting system not to comprise a hanger. In this case, the paint booth 20 is located on a platform S located in the open air (outside a hanger). For the remainder of the description, a longitudinal direction is a horizontal direction (substantially parallel to the platform S) and substantially parallel to the first and second lateral walls 22, 24. A vertical median plane VMP is a vertical plane, parallel to the longitudinal direction, positioned equidistant from the first and second lateral walls 22, 24. A transverse plane is a vertical plane and perpendicular to the vertical median plane VMP. A transverse direction is a horizontal direction and perpendicular to the longitudinal direction.

The walls 22, 24, 26 are rigid and have a length (dimension taken in the longitudinal direction) which is greater than or equal to the length of the fuselage 12 so that the fuselage 12 of the aircraft can be contained within the internal zone delimited by the paint booth 20.

According to one particularity, the first and second lateral walls 22, 24 comprise first and second lateral openings 22.1, 24.1 which are dimensioned to permit the wings 14 to pass through the first and second lateral walls 22, 24, leaving a small clearance around the wings 14. Due to these lateral openings 22.1, 24.1, the first and second lateral walls 22, 24 are brought adjacent to the fuselage 12, which makes it possible to reduce the volume of the internal zone in which the fuselage 12 is positioned. According to one arrangement, the fuselage 12 is centered approximately between the first and second lateral walls 22, 24. According to one configuration, the first and second lateral walls 22, 24 are spaced apart by a distance of between 1.5 and 3 times the width of the fuselage. Generally, each first or second lateral wall 22, 24 is positioned between the fuselage 12 and the propulsion system 18 closest to the fuselage 12.

According to one embodiment, for at least one of the first and second lateral openings 22.1, 24.1, the paint booth 20 comprises at least one flexible barrier, such as a curtain for example, which is fixed to the first or second lateral wall 22, 24 and which is configured to fill up the space between the first or second lateral wall 22, 24 and the wing 14 and thus completely seal the first or second lateral opening 22.1, 24.1. According to one configuration, the painting system comprises at least one flexible barrier in the region of each of the first and second lateral openings 22.1, 24.1.

According to an embodiment which is visible, in particular, in FIG. 4, the upper wall 26 comprises an upper opening 26.1 which is dimensioned to permit the tail unit 16, and more particularly its vertical part 16.1, to pass through the upper wall 26, leaving a small clearance around the tail unit 16. Due to this upper opening 16.1, the upper wall 26 can be brought adjacent to the fuselage 12 which makes it possible to reduce the volume of the internal zone in which the fuselage 12 is positioned. To provide an order of magnitude, the upper wall 26 is separated from the platform S by a distance of between 1.5 and 3 times the height of the fuselage 12 (dimension taken in a vertical direction).

According to one configuration, the paint booth 20 comprises at least one flexible barrier, such as a curtain for example, which is fixed to the upper wall 26 and which is configured to fill up the space between the upper wall 26 and the tail unit 16 and thus completely seal the upper opening 26.1.

Naturally, the invention is not limited to these embodiments for the paint booth. Thus, it is possible for the walls 22, 24, 26 not to be rigid. Whatever the embodiment, the paint booth 20 comprises at least the first and second lateral openings 22.1, 24.1 which are configured to permit the wings of the aircraft to pass through the paint booth 20. This solution makes it possible to obtain a paint booth 20 of reduced cross section. According to one configuration, the paint booth 20 comprises an upper opening 26.1 which is dimensioned to permit the tail unit 16 to pass through the paint booth 20. This paint booth has a tunnel shape (which is shaped, for example, by the walls 22, 24, 26) and having a length which is greater than or equal to that of the fuselage 12 and a width which is less than three times the width of the fuselage 12.

The provision of a paint booth 20 of small sections, which are adapted to those of the fuselage, makes it possible to reduce the volume of air to be treated by a ventilation and extraction system and to be heated for drying the paintwork, which makes it possible to reduce the energy consumption for the treatment of the air and the drying. Reducing the volume of air present in the paint booth 20 also makes it possible to facilitate and optimize the management of the characteristics of the air (temperature, humidity, quality, etc.).

The painting system comprises at least one ventilation and extraction system 28 comprising at least one ventilation outlet 30 which is configured to inject a gas (in particular, air) into the paint booth 20 and which is positioned in the region of a first zone of the paint booth 20, in addition to at least one extraction outlet 32 which is configured to extract the gas (in particular, air) present in the paint booth 20 and which is positioned in the region of a second zone of the paint booth 20 opposing the first zone. According to one arrangement, the ventilation and extraction system 28 comprises a plurality of ventilation outlets 30 which are distributed uniformly between the first and second ends 20.1, 20.2 of the paint booth 20 and/or a plurality of extraction outlets 32 which are distributed uniformly between the first and second ends 20.1, 20.2 of the paint booth 20.

The ventilation and extraction system 28 can comprise at least one control system, making it possible to control the gas flow exiting from the ventilation outlets 30 and/or entering the extraction outlets 32, the temperature and/or humidity of the gas leaving the ventilation outlets 30 or any other characteristics of the gas exiting from the ventilation outlets 30 and/or entering the extraction outlets 32.

Combining a paint booth 20 of small dimensions, which are adapted to those of the fuselage, and a ventilation and extraction system 28 makes it possible to obtain (uninterrupted) laminar flows around the fuselage 12, which avoids the particles of paint being held in suspension and limits the phenomena of the deposit of paint on the walls of the paint booth 20 and, as a result, the separation of particles which are capable of adhering to the fresh paintwork and damaging the quality of the paint coating.

Naturally, the invention is not limited to a gas such as air. Thus the gas could be nitrogen or a mixture of air enriched with nitrogen to reduce the concentration of oxygen. This solution makes it possible to reduce or eliminate the risks of explosion and fire. Moreover, in these conditions, the application of paint is less sensitive to the temperature and humidity conditions.

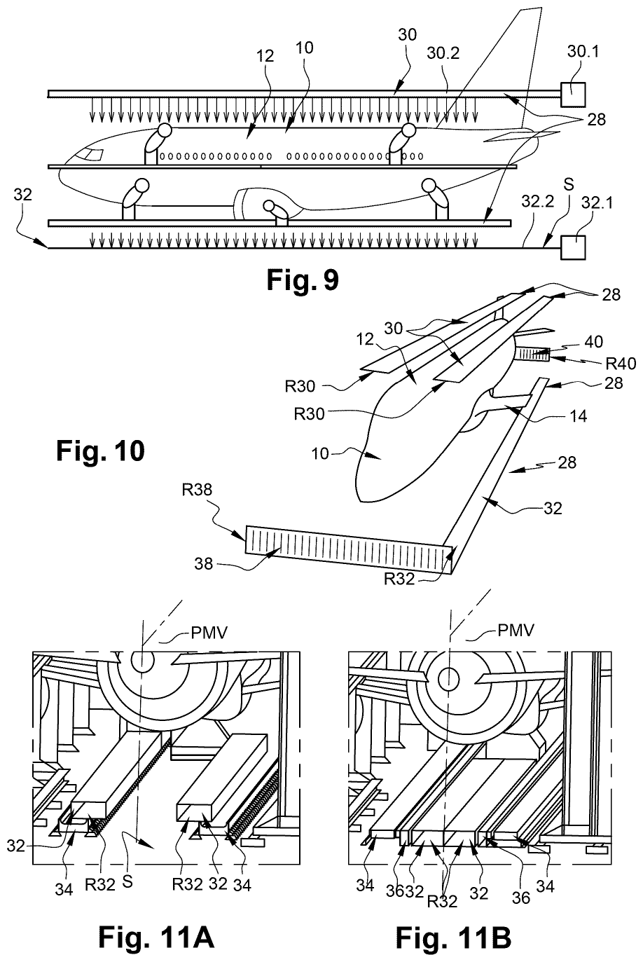

According to one configuration, the ventilation and extraction outlets 30, 32 are positioned in the region or in the vicinity of the upper wall 26 and the platform S. According to one arrangement, the ventilation outlets 30 are positioned in the region or vicinity of the upper wall 26 and the extraction outlets 32 are positioned in the region or vicinity of the platform S as illustrated in FIG. 9.

Naturally, the invention is not limited to this arrangement. Thus, the ventilation and extraction outlets 30, 32 could be positioned at each end of the fuselage so as to generate a horizontal gas flow.

According to one embodiment, the ventilation and extraction system 28 comprises at least two longitudinal rows R30 of ventilation outlets 30, which are symmetrical relative to the vertical median plane VMP and which each extend from the first end 20.1 of the paint booth 20 to its second end 20.2. According to one configuration, the ventilation and extraction system 28 comprises at least one air flow generator 30.1, in addition to at least one ventilation duct 30.2 for each row R30 of ventilation outlets 30, the ventilation duct extending parallel to the vertical median plane VMP and comprising an end connected to the air flow generator 30.1 and the ventilation duct 30.2 having a plurality of orifices and/or slots which form the ventilation outlets 30. Whatever the configuration, the rows R30 of ventilation outlets 30 are positioned above the fuselage 12 in the upper part of the paint booth 20 and the closest possible to the vertical median plane VMP, the rows R30 of ventilation outlets being separated by a distance of less than the width of the fuselage 12. As a variant, the ventilation and extraction system 28 can comprise a plurality of ventilation ducts 30.2 which are connected to the same air flow generator 30.1.

Naturally, the invention is not limited to this embodiment. Thus, the ventilation and extraction system 28 can comprise only a single longitudinal row of ventilation outlets perpendicular to the vertical median plane VMP. As a variant, the ventilation and extraction system 28 can comprise two principal longitudinal rows of ventilation outlets which are symmetrical relative to the vertical median plane VMP and in the vicinity thereof, in addition to two secondary longitudinal rows of ventilation outlets which are symmetrical relative to the vertical median plane VMP and spaced apart therefrom. Preferably, the two principal longitudinal rows generate a significant air flow while the two secondary longitudinal rows generate a smaller air flow and contribute to reducing the occurrence of turbulent flows in the upper corners of the paint booth 20.

According to one embodiment, the ventilation and extraction system 28 comprises at least two longitudinal rows R32 of extraction outlets 32 which are symmetrical relative to the vertical median plane VMP and which each extend from the first end 20.1 of the paint booth 20 to its second end 20.2. According to one configuration, the ventilation and extraction system 28 comprises at least one air extractor 32.1, in addition to at least one extraction duct 32.2 for each row R32 of extraction outlets 32, the extraction duct extending parallel to the vertical median plane VMP and comprising an end connected to the air extractor 32.1 and the extraction duct 32.2 having a plurality of orifices and/or slots which form the extraction outlets 32. Whatever the configuration, the rows R32 of extraction outlets 32 are positioned below the fuselage 12, in the lower part of the paint booth 20 and the closest possible to the vertical median plane VMP, the rows R32 of extraction outlets 32 being spaced apart by a distance of less than the width of the fuselage 12. As a variant, the ventilation and extraction system 28 can comprise a plurality of extraction ducts 32.2 which are connected to the same air extractor 32.1.

Naturally, the invention is not limited to this embodiment. Thus, the ventilation and extraction system 28 can comprise only a single longitudinal row of extraction outlets perpendicular to the vertical median plane VMP or two rows side-by-side in the region of the vertical median plane. As a variant, the ventilation and extraction system 28 can comprise two principal longitudinal rows of extraction outlets which are symmetrical relative to the vertical median plane VMP and in the vicinity thereof, in addition to two secondary longitudinal rows of extraction outlets which are symmetrical relative to the vertical median plane VMP and spaced apart therefrom.

According to one arrangement, each extraction duct 32.2 is positioned on the platform S. According to this arrangement, an infrastructure is not integrated in the platform S.

According to a configuration which is visible in FIGS. 11A and 11B, at least one of the extraction ducts 32.2 is mobile between a retracted position which is visible in FIG. 11A, in which it is spaced apart from the vertical median plane VMP and opens up a through-passage for at least one of the landing gears of the aircraft 10, in addition to a deployed position which is visible in FIG. 11B, in which it is brought adjacent to the vertical median plane VMP and rests on the platform S. According to one configuration, the ventilation and extraction system 28 comprises two extraction ducts 32.2 which are symmetrical relative to the vertical median plane and mobile between the retracted and deployed positions, the two extraction ducts 32.2 being side-by-side in the deployed position. This configuration makes it possible to position the extraction outlets 32 in the closest possible position to the vertical median plane VMP when the extraction ducts 32.2 are in the deployed position, while permitting the positioning of an aircraft 10 in the paint booth 20 when the extraction ducts 32.2 are in the retracted position and release the platform S. According to one embodiment, the ventilation and extraction system 28 comprises a longitudinal support 34 which is fixed to the platform S, for each extraction duct 32.2, in addition to a joint 36 connecting the longitudinal support 34 and the extraction duct 32.2.

According to one embodiment, each extraction duct 32.2 is a rigid tubular duct of square or rectangular cross section. By way of example, the joint 36 comprises two connecting rods which each have a first end connected to the longitudinal support 34 and a second end connected to the extraction duct 32.2. The ventilation and extraction system 28 can comprise at least one motorization system to cause the displacement of each extraction duct 32.2 between the retracted and deployed positions.

According to one embodiment visible in FIG. 10, the ventilation and extraction system 28 comprises at least one extraction outlet 38 with an end positioned in the region of the first end 20.1 of the paint booth 20. According to one arrangement, the ventilation and extraction system 28 comprises at least one row R38 of extraction outlets 38 with an end perpendicular to the vertical median plane VMP and positioned in the region of the first end 20.1 of the paint booth 20.

According to one embodiment visible in FIG. 10, the ventilation and extraction system 28 comprises at least one extraction outlet 40 with an end positioned in the region of the second end 20.2 of the paint booth 20. According to one arrangement, the ventilation and extraction system 28 comprises at least one row R40 of extraction outlets 40 with an end perpendicular to the vertical median plane VMP and positioned in the region of the second end 20.2 of the paint booth 20.

Positioning the extraction outlets 38, 40 with an end in the region of the first and second ends 20.1, 20.2 of the paint booth 20 makes it possible to avoid the occurrence of turbulent flows due to the conical shape of the front and rear tips 12.1, 12.2 of the fuselage 12.

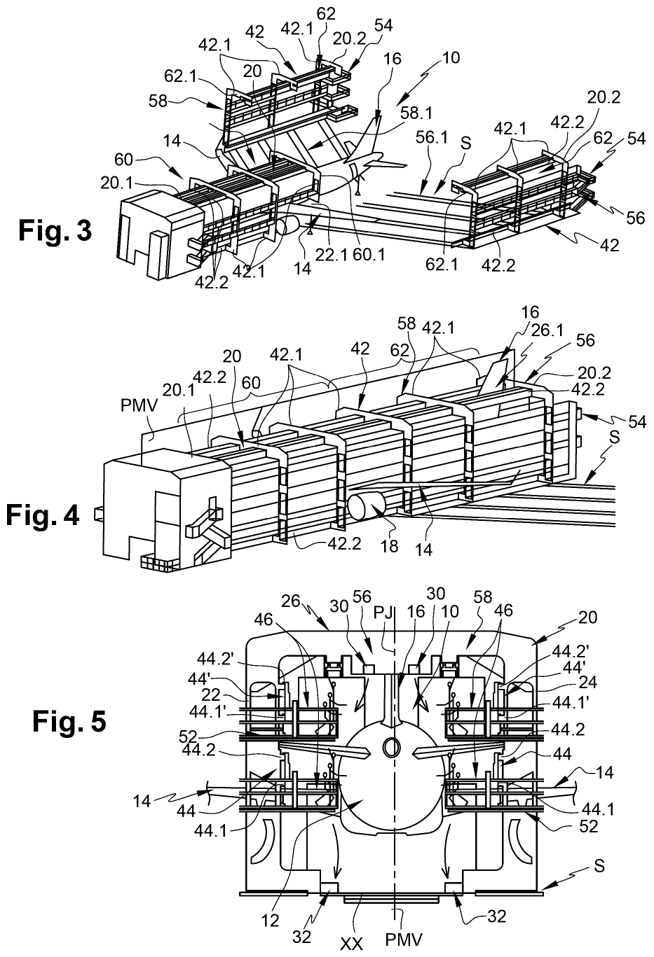

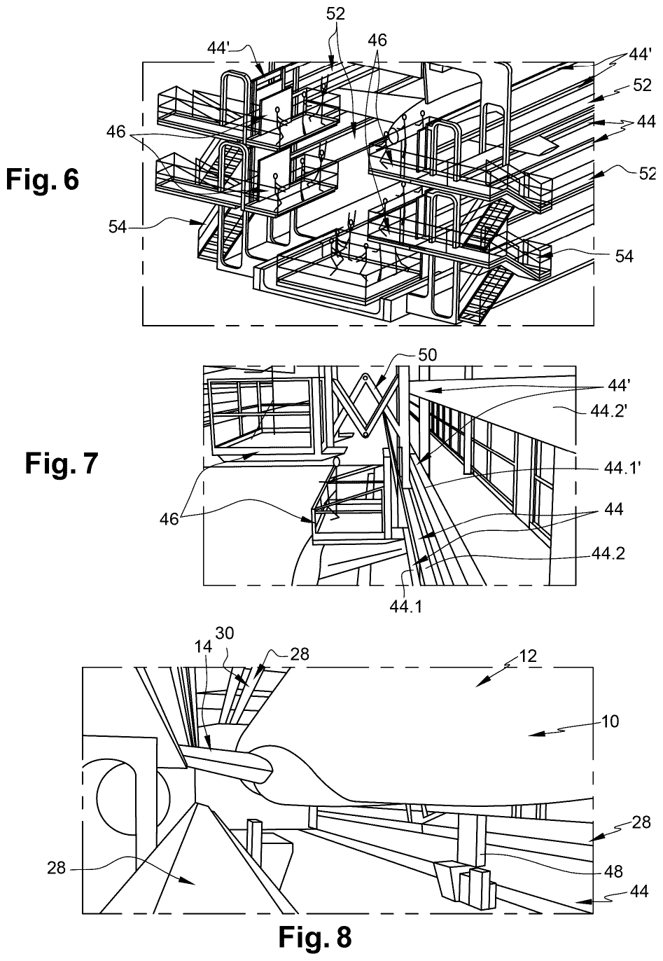

The paint booth 20 comprises at least one structure 42 (visible in FIGS. 3 and 4) supporting the first and second lateral walls 22, 24, in addition to the upper wall 26. According to one embodiment, the structure 42 comprises frames 42.1 which are positioned in the transverse planes, in addition to longitudinal members 42.2 which connect the frames 42.1 together and which are oriented parallel to the longitudinal direction. Naturally, the invention is not limited to this configuration of the structure 42.

According to one embodiment, the paint booth 20 comprises a plurality of longitudinal sliders 44 which are fixed to the structure 42, which are parallel to one another and to the longitudinal direction and which are positioned on either side of the vertical median plane VMP. According to an arrangement visible in FIG. 5, the structure 42 comprises a plurality of longitudinal sliders 44, 44′ which are offset in terms of height on either side of the vertical median plane VMP. By way of example, the structure 42 comprises two longitudinal sliders 44, 44′ on each side of the vertical median plane VMP. According to one configuration, each longitudinal slider 44, 44′ comprises two longitudinal rails 44.1, 44.2, 44.1′, 44.2′ which are offset in terms of height.

Each slider 44, 44′ is configured to permit at least one support, such as a cradle 46 (visible in FIG. 7) or a carriage 48 (visible in FIG. 8), to be displaced along the fuselage 12 which is positioned in the paint booth 20, by sliding along the slider 44, 44′. According to one arrangement visible in FIG. 7, the cradle 46 can be connected to the slider 44 by at least one telescopic connection 50 which is configured to displace the cradle 46 relative to the slider 44, 44′ in a transverse direction.

Each slider 44, 44′ can comprise a plurality of sections positioned end-to-end.

The paint booth 20 can comprise galleries 52 which are distributed on a plurality of levels and configured to permit operators to be displaced around the fuselage 12, in addition to stairs and/or lifts 54 for passing from one gallery 52 to another.

According to one embodiment, the paint booth 20 comprises at least the first and second parts 56, 58 which respectively comprise at least one part of the first and second lateral walls 22, 24, at least one of the first and second parts 56, 58 being mobile between a spaced-apart position corresponding to an open state of the paint booth 20, as illustrated in FIGS. 1 to 3, in which a fuselage of an aircraft can be positioned between the first and second parts 56, 58, in addition to an adjacent position corresponding to a closed state of the paint booth 20 as illustrated in FIGS. 4 and 5.

The first part 56 comprises at least one part of the first lateral wall 22, in addition to a first portion of the upper wall 26. The second part 58 comprises at least one part of the second lateral wall 24, in addition to a second portion of the upper wall 26, the first and second portions of the lateral wall being joined along a joining plane PJ (visible in FIG. 5) when the first and second parts 56, 58 are brought adjacent to one another and the paint booth 20 is in the closed state.

According to one configuration, the first and second parts 56, 58 are substantially symmetrical relative to the vertical median plane VMP. In this case, the joining plane PJ is merged with the vertical median plane VMP when the first and second parts 56, 58 are brought adjacent to one another. According to this configuration, the first and second portions of the upper wall 26 comprise cutouts 26.2, 26.3 so as to form the upper opening 26.1 when the first and second parts 56, 58 are brought adjacent to one another.

According to one embodiment, the first and second parts 56, 58 are mobile between the open and closed states.

According to one configuration, for each of the first and second parts 56, 58, the painting system comprises at least one sliding connection 56.1, 58.1 which connects the first or second part 56, 58 and the platform S and which is configured to permit the first or second part 56, 58 to be translated between the open and closed states.

During operation, when the fuselage 12 of the aircraft 10 to be painted is positioned in the paint booth 20, the aircraft longitudinal axis XX is positioned substantially in the vertical median plane VMP. To reduce the dimensions of the lateral openings 22.1, 24.1, each sliding connection 56.1, 58.1 forms with the vertical median plane VMP an angle which is substantially equal to that formed between the fuselage 12 and each wing 14. According to one embodiment, each sliding connection 56.1, 58.1 comprises a plurality of rails which are parallel to one another and which form an angle which is substantially equal to that formed between the fuselage 12 and the corresponding wing 14. Thus, when the aircraft is positioned to be painted, the rails associated with the first or second part 56, 58 are substantially parallel to the trailing edge 14.1 of the wing 14 which cooperates with the corresponding first or second part 56, 58.

According to one configuration, for each of the first and second parts 56, 58, the painting system comprises at least one motorization system for displacing the first and second parts 56, 58.

According to an embodiment visible in FIGS. 1 to 4, the paint booth 20 comprises a first section 60 which is configured to house the front part 12A, in addition to a second section 62 which is configured to house the rear part 12B. The first and second sections 60, 62 respectively comprise first and second terminal faces 60.1, 62.1 which are positioned in the transverse planes. At least one of the first and second sections 60, 62 is mobile between a first position corresponding to the closed state of the paint booth 20 in which the first and second transverse faces 60.1, 62.1 are placed against one another, in addition to a second position corresponding to the open state of the paint booth 20 in which the first and second transverse faces 60.1, 62.1 are spaced apart from one another.

According to one configuration, the first section 60 is fixed. In addition, the second section 62 comprises first and second parts 56, 58 which are mobile between a position spaced-apart from the vertical median plane, which corresponds to the open state of the paint booth 20 (visible in FIGS. 1 to 3), and a position adjacent to the vertical median plane, which corresponds to the closed state of the paint booth 20 (visible in FIG. 4). This configuration makes it possible to limit the dimensions of the parts in terms of their movement and their path.

According to one arrangement, the first section 60 comprises lateral openings 22.1, 24.1 which open out into the region of the first terminal face 60.1. As a variant, the lateral openings 22.1, 24.1 are located on the second section 62 or overlap with the first and second sections 60, 62.

According to one mode of operation, the fuselage 12 of the aircraft 10 is painted during a first phase, then the wings 14 and the tail unit 16 are painted during a second phase.

As illustrated in FIG. 1, since the first and second parts 56, 58 of the second section 62 are in the spaced-apart position, an aircraft 10 to be painted is displaced so that its front part 12A is introduced into the first section 60, as illustrated in FIGS. 2 and 3. Subsequently, the first and second parts 56, 58 are displaced so as to close the paint booth 20 as illustrated in FIGS. 4 and 5.

Naturally, the invention is not limited to the embodiment described in FIGS. 1 to 5 for the paint booth 20. Further solutions are conceivable in order to obtain a paint booth 20 of small dimensions which make it possible to confine the fuselage 12 to be painted in a reduced volume. Thus, the first and second parts 56, 58 could extend from the first end 20.1 of the paint booth 20 to its second end 20.2. Whatever the embodiment, the paint booth 20 comprises at least two elements, namely the first and second parts 56, 58 and/or the first and second sections 60, 62; at least one of the two elements being mobile between an adjacent position corresponding to the closed state of the paint booth 20 in which the two elements are joined, in addition to a spaced-apart position corresponding to the open state of the paint booth 20 in which a fuselage of an aircraft can be positioned between the two elements.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A painting system suitable for painting a fuselage of an aircraft, the aircraft comprising wings and a tail unit, and each wing forming a given angle with the fuselage and the painting system comprising a platform, wherein the painting system comprises:
a paint booth which is positioned on the platform and which comprises at least first and second lateral openings which are configured to permit the wings of the aircraft to pass through the paint booth,
at least two elements, at least one of the two elements being mobile between
an adjacent position corresponding to a closed state of the paint booth in which the two elements are joined together, and
a spaced-apart position corresponding to an open state of the paint booth in which the fuselage can be positioned between the two elements.

2. The painting system according to claim 1, wherein the paint booth comprises an upper opening which is dimensioned to permit the tail unit to pass through the paint booth.

3. The painting system according to claim 2, wherein the paint booth comprises at least first and second parts, the first part comprising at least one part of a first lateral wall, in addition to a first portion of an upper wall, the second part comprising at least one part of a second lateral wall, in addition to a second portion of the upper wall, the first and second portions of the upper wall being joined together when the first and second parts are in the adjacent position, and the first and second portions of the upper wall comprising cutouts so as to form the upper opening when the first and second parts are in the adjacent position.

4. The painting system according to claim 3, wherein the first and second parts are mobile between the adjacent and spaced-apart positions and symmetrical relative to a vertical median plane.

5. The painting system according to claim 4, wherein, for each of the first and second parts, the painting system comprises at least one sliding connection which connects the first or second part and the platform and which is configured to permit the first or second part to be translated between the adjacent and spaced-apart positions, each sliding link forming with the vertical median plane an angle which is substantially equal to that formed between the fuselage and each wing.

6. The painting system according to claim 4, wherein the paint booth comprises first and second sections, respectively comprising first and second terminal faces which are positioned in transverse planes perpendicular to the vertical median plane, at least one of the first and second sections being mobile between a first position in which first and second transverse faces are placed against one another, in addition to a second position in which the first and second transverse faces are spaced apart from one another.

7. The painting system according to claim 6, wherein
the first section is fixed, and
the second section comprises first and second parts which are mobile between a position which is spaced apart from the vertical median plane and a position which is adjacent to the vertical median plane.

8. The painting system according to claim 7, wherein the first section comprises the first and second lateral openings which open out in a region of the first terminal face.

9. The painting system according to claim 2, wherein the paint booth comprises at least one flexible barrier which is configured to fill up a space between a cockpit and the tail unit and thus completely seal the upper opening.

10. The painting system according to claim 1, wherein the paint booth comprises at least one flexible barrier for at least one of the first and second lateral openings, the flexible barrier being configured to fill up a space between the paint booth and the wing and thus completely seal the first or second lateral opening.

11. The painting system according to claim 3, wherein the paint booth comprises a structure which is configured to support the walls, in addition to a plurality of longitudinal sliders which are fixed to the structure, which are parallel to one another and which are configured to permit at least one support to be displaced along the fuselage which is positioned in the paint booth by sliding along the slider.
